(19) United States
(12) Patent Application Publication
(10) Pub. No.: US 2018/0088326 A1
(43) Pub. Date: Mar. 29, 2018

(54) WINDSHIELD HEAD UP DISPLAY SYSTEM

(71) Applicant: Panasonic Automotive Systems Company of America, Division of Panasonic Corporation of North America, Peachtree City, GA (US)

(72) Inventors: DAVID KAY LAMBERT, STERLING HEIGHTS, MI (US); WALTER JOSEPH NILL, DAVISON, MI (US)

(73) Assignee: Panasonic Automotive Systems Company of America, Division of Panasonic Corporation of North America

(21) Appl. No.: 15/710,615

(22) Filed: Sep. 20, 2017

Related U.S. Application Data
(60) Provisional application No. 62/401,408, filed on Sep. 29, 2016.

(51) Int. Cl. G02B 27/01; B32B 17/10; G02B 5/30

(52) U.S. Cl. CPC G02B 27/0101; B32B 17/10036; G02B 2027/0192; B60K 2350/2052; G02B 5/30

(57) ABSTRACT

A motor vehicle includes a head up display projector emitting a light field. A windshield includes an outer layer of glass, an inner layer of glass, and a plastic layer sandwiched between the outer layer of glass and the inner layer of glass. The light field is reflected toward eyes of a driver of the motor vehicle by a reflective material added to one of an inner surface of the plastic layer, an outer surface of the plastic layer, an inner surface of the outer layer of glass, and an outer surface of the inner layer of glass.

### CROSS-REFERENCE TO RELATED APPLICATION

This application claims benefit of U.S. Provisional Application No. 62/401,408 filed on Sep. 29, 2016, which the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Next, the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

Current practice is to use reflection from the interior and exterior glass-air interfaces of the front windshield to reflect light from the head up display projector to be seen as a virtual image by the driver. The windshield is wedged so the images reflected from these two surfaces are exactly on top of each other, or superimposed with each other, as seen by the driver. The fraction of light from the projector that is reflected is controlled by the index of refraction of the glass.

Conventionally, a windshield consists of three layers: a layer of glass, a layer of plastic (typically polyvinyl butyral), and another layer of glass. The plastic layer is chosen to have the same index of refraction as the glass, so there is no reflection from the interface between the plastic and the glass. The use of a film on the surface of the windshield facing the interior of the vehicle has been used to increase reflectivity for light from a head up display, but this configuration has not been accepted by customers.

One problem is that many drivers that use a head up display are unhappy about not being able to easily see the light from the head up display while wearing polarized sunglasses. Another problem is that, in order to use a head up display in a vehicle, it is necessary to use a wedged windshield, which adds cost and complexity. The replacement cost for a wedged windshield is high.

### SUMMARY

The present invention may use reflection of light from a front windshield to create a virtual image that can be viewed by the driver. The invention can increase the fraction of the light emitted by the head up display that is seen be the driver. This makes it possible to reduce the amount of light that needs to be emitted by the head up display with corresponding reduction in cost, mass, energy use, and waste heat.

In one embodiment, the invention comprises a motor vehicle including a head up display projector emitting a light field. A windshield includes an outer layer of glass, an inner layer of glass, and a plastic layer sandwiched between the outer layer of glass and the inner layer of glass. The light field is reflected toward eyes of a driver of the motor vehicle by a layer added to one of: an inner surface of the plastic layer, an outer surface of the plastic layer, an inner surface of the outer layer of glass, and an outer surface of the inner layer of glass.

In another embodiment, the invention comprises a motor vehicle including a head up display projector emitting a light field. A windshield includes an outer layer of glass and an inner layer of glass. Two plastic layers are sandwiched between the outer layer of glass and the inner layer of glass. A plastic film is sandwiched between the two plastic layers. The plastic film reflects the light field toward eyes of a driver of the motor vehicle.

In yet another embodiment, the invention comprises a motor vehicle including a head up display projector emitting a light field. A windshield includes an outer layer of glass, an inner layer of glass, and a plastic layer sandwiched between the outer layer of glass and the inner layer of glass. A plastic film is disposed on an inner surface of the inner layer of glass and reflects the light field toward eyes of a driver of the motor vehicle.

An advantage of the present invention is that it may enable the light from the head up display to have the appropriate polarization state so as to be easily viewed through polarizing sunglasses. The invention may enable drivers wearing conventional polarizing sunglasses to see the virtual image from the head up display without loss due to the polarization of the light.

Another advantage is that the invention may eliminate the need for a wedged windshield by greatly reducing the ghost image associated with reflection from the exterior and interior surfaces of the front windshield.

Yet another advantage is that the invention may enhance reflectance of the light from the head up display to the driver so as to reduce the required luminance of the projector.

A further advantage is that the invention may be used to optimize the reflectivity from the windshield when used with an anti-reflective coating on one or more surfaces of the windshield.

### BRIEF DESCRIPTION OF THE DRAWINGS

A better understanding of the present invention will be had upon reference to the following description in conjunction with the accompanying drawings.

FIG. 1 is a schematic side view of a head up display arrangement of the present invention.

### DETAILED DESCRIPTION OF THE PREFERRED EMBODIMENTS

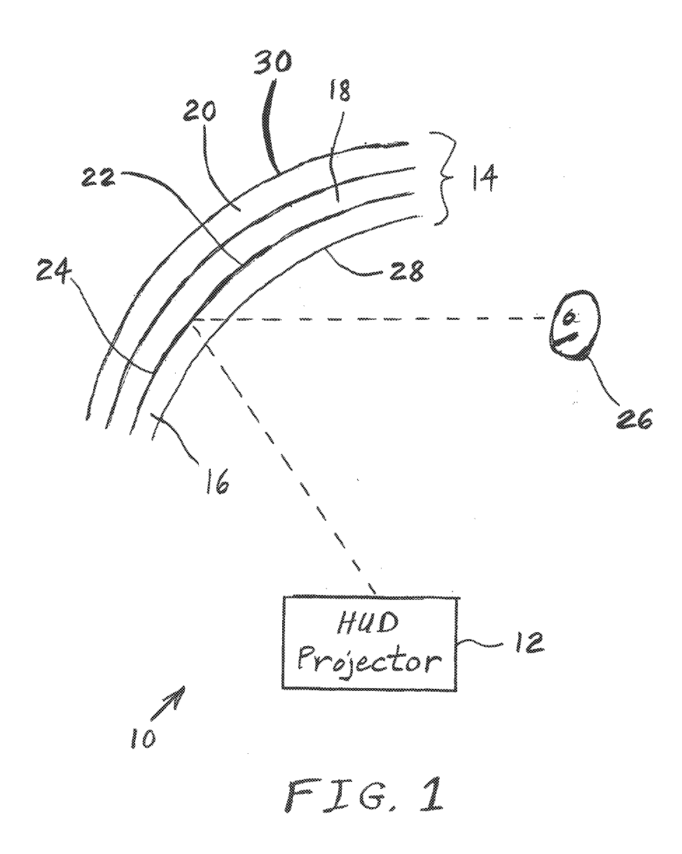

FIG. 1 illustrates in a one embodiment of a head up display arrangement 10 of the present invention, including a head up display projector 12 and a windshield 14. Windshield 14 includes an inner layer of glass 16, a plastic layer 18, and an outer layer of glass 20. A sputtered film 22 on an outer surface 24 of inner layer of glass 16 may provide partial broadband reflectivity to visible light. Arrangement 10 differs from conventional practice in that the primary reflective surface is at a glass surface 24 inside windshield 14 that has been coated to reflect light. Windshield 14 meets light transmission requirements to enable a driver 26 to see through windshield 14. In the U.S., the front windshield typically needs to transmit 70% of incident light, weighted by the standard optical response of the eye. Reflective film 22 can be uniform across the entire windshield 14.

Film 22 deposited on surface 24 within windshield 14 may provide partial reflectivity to visible light. Light from head up display projector 12 may reflect from partially reflective film layer 22. The light from head up display projector 12 can be linearly polarized so that most of the reflection is from the deposited film 22 rather than from the air-glass interfaces 28, 30.

In one embodiment, light reflected from the windshield to the driver is linearly polarized for maximum transmission by conventional polarized sunglasses. Accordingly, the head up display emits linearly polarized light with electric field in the plane of incidence.

In one embodiment, the head up display emits linearly polarized light to minimize reflection from the front and back surfaces of the windshield. This may make it unnecessary to use a wedged windshield to avoid seeing an objectionable double image with the head up display. As in the previous embodiment, the light emitted by the head up display is linearly polarized with electric field in the plane of incidence.

In another embodiment, the reflective surface is on a plastic film sandwiched between two plastic layers inside the windshield. That is, the plastic film and two plastic layers are sandwiched between an inner layer of glass and an outer layer of glass. For example, the plastic film can be sandwiched between two layers of polyvinyl butyral (PVB) that together form the plastic interlayer of the windshield. In one embodiment, nothing is applied to the film. The optical properties of the plastic film material, and the differences between these properties and the optical properties of PVB, cause the reflection.

In another embodiment, the reflective film is applied to one side of the thin glass sheet used for the side of the windshield that faces the interior of the vehicle. The reflective film is applied while the glass sheet is flat, and before the glass sheet has been shaped into the curved form of the windshield.

In another embodiment, the head up display emits unpolarized light or light polarized in a state that does not minimize reflection at the air-glass surface. By using an additional reflective surface besides the front and back air-glass interface surfaces, the fraction of light emitted by the head up display that is seen by the driver is substantially increased.

In another embodiment, the reflective layer inside the windshield, as described herein, is used together with an antireflective layer applied to the surface of the windshield facing the interior of the vehicle and/or an antireflective layer applied to the surface of the windshield facing the exterior of the vehicle. In some circumstances, it is advantageous to decrease the veiling glare, in which the windshield reflects light coming from the vehicle dash. The reflected light from the dash may, in some situations, decrease the ability of the driver to detect safety hazards, such as pedestrians or other vehicles. However, decrease of windshield reflectivity also reduces the fraction of light from a head up display that is reflected to be seen by the driver. By the use of both a means to reduce reflection from the windshield, such as a moth-eye antireflective coating, and the present invention, it is possible to optimize the fraction of light reflected both from the top of the dash and from the head up display, to be seen by the driver.

In the various embodiments, the reflection may be from a thin metal film; from a multi-layer dielectric film optimized to provide partial broadband reflectivity in the visible wavelength range; from a single layer of a material such as a metal-oxide or a semiconductor; or from a combination of the above. The reflective film could be on the surface of glass facing the plastic, either of the layer of windshield glass adjacent to the interior of the vehicle or the layer of windshield glass adjacent to the exterior of the vehicle.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
a head up display projector configured to emit a light field; and
a windshield including:
an outer layer of glass;
an inner layer of glass; and
a plastic layer sandwiched between the outer layer of glass and the inner layer of glass;
wherein the light field is reflected toward eyes of a driver of the motor vehicle by a reflective material added to one of:
an inner surface of the plastic layer;
an outer surface of the plastic layer;
an inner surface of the outer layer of glass; and
an outer surface of the inner layer of glass.

2. The motor vehicle of claim 1 wherein the light field is reflected by a sputtered film on the one of:
the inner surface of the plastic layer,
the outer surface of the plastic layer;
the inner surface of the outer layer of glass; and
the outer surface of the inner layer of glass.

3. The motor vehicle of claim 1 wherein the light field is linearly polarized.

4. The motor vehicle of claim 1 wherein the plastic layer is formed of polyvinyl butyral.

5. The motor vehicle of claim 1 further comprising a first antireflective layer applied to an inner surface of the inner layer of glass, and a second antireflective layer applied to an outer surface of the outer layer of glass.

6. The motor vehicle of claim 1 wherein the light field is reflected by one of:
a thin metal film;
a multi-layer dielectric film;
a single layer of a metal-oxide material; and
a single layer of a semiconductor material.

7. The motor vehicle of claim 1 wherein the light field includes unpolarized light or light polarized in a state that does not minimize reflection at interfaces between air and each of the layers of glass.

8. A motor vehicle, comprising:
a head up display projector configured to emit a light field; and
a windshield including:
an outer layer of glass;
an inner layer of glass;
two plastic layers sandwiched between the outer layer of glass and the inner layer of glass; and
a plastic film sandwiched between the two plastic layers, the plastic film being configured to reflect the light field toward eyes of a driver of the motor vehicle.

9. The motor vehicle of claim 8, wherein the one of the following is deposited on the plastic film by sputtering:
a thin metal film;
a multi-layer dielectric film;
a single layer of a metal-oxide material; and
a single layer of a semiconductor material.

10. The motor vehicle of claim 8 wherein the light field is linearly polarized.

11. The motor vehicle of claim 8 wherein the two plastic layers are formed of polyvinyl butyral.

12. The motor vehicle of claim 8 further comprising a first antireflective layer applied to an inner surface of the inner layer of glass, and a second antireflective layer applied to an outer surface of the outer layer of glass.

13. The motor vehicle of claim 8 wherein the light field is reflected by one of the following on the plastic film:
a thin metal film;
a multi-layer dielectric film;
a single layer of a metal-oxide material; and
a single layer of a semiconductor material.

14. The motor vehicle of claim 8 wherein the light field includes unpolarized light or light polarized in a state that does not minimize reflection at interfaces between air and each of the layers of glass.

15. A motor vehicle, comprising:
a head up display projector configured to emit a light field; and
a windshield including:
an outer layer of glass;
an inner layer of glass;
a plastic layer sandwiched between the outer layer of glass and the inner layer of glass; and
a plastic film disposed on an inner surface of the inner layer of glass and configured to reflect the light field toward eyes of a driver of the motor vehicle.

16. The motor vehicle of claim 15, wherein the one of the following is deposited on the plastic film by sputtering:
a thin metal film;
a multi-layer dielectric film;
a single layer of a metal-oxide material; and
a single layer of a semiconductor material.

17. The motor vehicle of claim 15 wherein the light field is linearly polarized.

18. The motor vehicle of claim 15 wherein the plastic layer is formed of polyvinyl butyral.

19. The motor vehicle of claim 15 further comprising a first antireflective layer applied to an inner surface of the inner layer of glass, and a second antireflective layer applied to an outer surface of the outer layer of glass.

20. The motor vehicle of claim 15 wherein the light field is reflected by one of the following on the plastic film:
a thin metal film;
a multi-layer dielectric film;
a single layer of a metal-oxide material; and
a single layer of a semiconductor material.

21. The motor vehicle of claim 15 wherein the light field includes unpolarized light or light polarized in a state that does not minimize reflection at interfaces between air and each of the layers of glass.
